(19) United States
(12) Patent Application Publication
(10) Pub. No.: US 2026/0329729 A1
(43) Pub. Date: Oct. 22, 2026

(54) AUTONOMOUS, CONTEXT-AWARE, EVENT-DRIVEN SOFTWARE TESTING USING NATURAL LANGUAGE SCENARIO ABSTRACTION AND PROGRESSIVE HUMAN-IN-THE-LOOP DELEGATION

(71) Applicant: Perforce Software, Inc., Minneapolis, MN (US)

(72) Inventors: Yoram Mizrachi, Herzeliya (IL); Rodney Cope, Bennett, CO (US)

(21) Appl. No.: 19/648,193

(22) Filed: Apr. 15, 2026

Related U.S. Application Data
(60) Provisional application No. 63/791,855, filed on Apr. 21, 2025.

(51) Int. Cl. G06F 11/3668

(52) U.S. Cl. CPC G06F 11/3672

(57) ABSTRACT

Disclosed herein are systems and methods that can autonomously construct application knowledge models from multi-source observations including inferred business intent, generate and execute natural language-based test scenarios in response to external events and internal analytics, dynamically manage testing platform coverage through policy-based tier abstractions with automated resolution against real-time analytics, perform intelligent test orchestration with diagnostic failure classification, manage testing infrastructure through progressive human-in-the-loop delegation, and maintain closed-loop defect lifecycle management across heterogeneous platforms and testing purposes.

### CROSS-REFERENCE TO RELATED APPLICATIONS

This application claims priority to, and the benefit of, U.S. Provisional Patent Application number 63/791,855, filed on Apr. 21, 2025, entitled “Contextual Semantics for Testing,” the entire contents of which are hereby incorporated by reference. In addition, this application is related to the same applicant's concurrently filed and co-pending U.S. Patent Application entitled “Dynamic Contextual Caching of Large Language Model Results Using Adaptive Spatial Relevance Learning and Multi-Step Cache Key Chaining,” the entire contents of which are hereby incorporated by reference. For example, the agentic execution components described herein may employ the contextual caching mechanisms described in applicant's other co-pending application, such as to improve performance and reduce computational cost.

### TECHNICAL FIELD

Embodiments disclosed herein relate generally to the field of automated software testing and quality assurance, and more specifically to systems and methods that autonomously construct application knowledge models from multi-source observations including inferred business intent, generate and execute natural language-based test scenarios in response to external events and internal analytics, dynamically manage testing platform coverage through policy-based tier abstractions with automated resolution against real-time analytics, perform intelligent test orchestration with diagnostic failure classification, manage testing infrastructure through progressive human-in-the-loop delegation, and maintain closed-loop defect lifecycle management across heterogeneous platforms and testing purposes.

### BACKGROUND

Automated software testing has become a critical component of modern software development and release cycles. Organizations invest significant resources in creating, maintaining, and executing test suites across multiple platforms (mobile, web, desktop), testing types (functional, performance, security, accessibility), and environments (devices, operating systems, network conditions). Despite advances in test automation frameworks, the industry continues to face fundamental challenges that limit the effectiveness, efficiency, and adaptability of automated testing.

First, existing test automation systems are predominantly reactive. Tests are created in response to requirements documents, executed on predefined schedules, and maintained when failures are observed. There is no systematic mechanism for the testing system itself to identify what needs to be tested based on external signals such as incoming defect reports, customer support interactions, production incidents, security vulnerability disclosures, or shifts in the device ecosystem. As a result, test coverage gaps persist until a human recognizes the need and manually creates new tests.

Second, test automation systems lack contextual understanding of the application under test. Traditional frameworks operate at the level of UI element locators, API endpoints, or code units without understanding the application's screen structure, navigation flows, semantic purpose of interface elements, business intent behind user flows, or relationship between different areas of functionality. This lack of contextual understanding means that test generation, maintenance, and failure analysis all require significant human interpretation and effort.

Third, the management of testing infrastructure—particularly device labs (physical devices, virtual devices, browsers), environment configurations, and test data—remains a largely manual process. When new devices/version/browser enter the market, when market share data shifts, or when production usage patterns change, a human must recognize these changes and manually adjust the testing strategy. There is no mechanism for the testing system to autonomously monitor relevant data sources and adapt its infrastructure and coverage strategy accordingly.

Fourth, existing approaches to incorporating artificial intelligence into test automation typically focus on narrow capabilities such as self-healing locators or flaky test detection. These approaches do not address the broader challenge of creating an autonomous testing agent that can operate with the judgment and initiative of a human team member—understanding context, responding to events, making decisions within appropriate authority boundaries, and learning from human feedback to progressively expand its autonomous capabilities.

Fifth, test scenario definitions in existing systems are tightly coupled to specific platforms, programming languages, and execution frameworks. A test written for Selenium/Playwright/Puppeteer or alike cannot be directly used for mobile testing; a functional test cannot serve as the basis for a performance or security test without substantial rework. This coupling results in duplicated effort and divergent test suites across platforms and testing purposes.

Sixth, organizations that adopt continuous integration practices frequently encounter what may be termed a “shadow testing loop” problem. Black-box regression testing suites, when executed as CI gate checks, produce an unacceptably high rate of false failures due to the combined variability of application state, test data, testing infrastructure (device flakiness, lab connectivity), and script brittleness. Because the CI gate produces a FAIL result in nearly every execution regardless of actual application quality, engineering teams learn to ignore the CI regression results and relegate comprehensive testing to an out-of-cycle, manually managed process. This undermines the fundamental value proposition of continuous integration and represents a systemic failure that no existing approach addresses holistically.

Seventh, current testing infrastructure management employs static device lists or simple attribute-based matching (e.g., “iOS 18, iPhone 15”). These approaches lead to coverage drift as operating system versions change, market share shifts, new devices enter the market, and device health degrades. Organizations that attempt to manage device coverage through dynamic approaches (e.g., “latest iOS version”) find these mechanisms insufficient for the multi-dimensional coverage problem that real-world testing requires, encompassing OS version, manufacturer, screen resolution, form factor, device performance tier, and regional preferences simultaneously.

Eighth, cloud-based testing systems face a deployment architecture challenge: comprehensive test verification often requires access to customer-premise systems (databases, internal APIs, backend services) to validate end-to-end behavior. Existing cloud testing systems cannot access these systems without requiring customers to expose inbound network endpoints, creating security and operational concerns that limit the scope of automated test verification.

### SUMMARY

What is needed is a comprehensive system that: (a) autonomously builds and maintains a rich contextual model of the application under test from multiple observation sources, including inferred business intent; (b) monitors diverse event streams and autonomously generates and executes test scenarios in response to relevant events; (c) dynamically manages testing platform coverage through policy-based tier abstractions that resolve against real-time analytics; (d) performs intelligent test orchestration with diagnostic failure classification to distinguish genuine defects from infrastructure noise; (e) maintains closed-loop defect lifecycle management; (f) enables secure access to customer-premise resources through outbound-only agent architecture; and (g) expresses all test scenarios in a natural language abstraction that is inherently platform-agnostic and multi-purpose.

Embodiments disclosed herein can provide a system and method for autonomous, context-aware, event-driven software testing.

A system and method for autonomous, context-aware, event-driven software testing can autonomously construct an application context model comprising a directed graph of screens, user interface elements, transitions, and an inferred business intent layer from multi-source observations including video analysis, design tools, documentation, and domain knowledge, with automatic cross-language and cross-platform semantic unification. An event-driven scenario lifecycle can monitor diverse event sources (e.g., defect reports, support tickets, CI/CD events, security advisories, production telemetry, and market data) and autonomously generates, executes, and manages natural language test scenarios in response, including automated exploratory testing of untested application paths. A self-optimizing analysis and adaptive infrastructure management engine can detect failure patterns, coverage gaps, and device health issues using computational analysis methods, manages coverage tiers through policy-based abstractions that resolve against real-time analytics to produce versioned device set snapshots, and performs intelligent test orchestration with diagnostic failure classification through structured retry sequences that distinguish genuine defects from device-specific issues and transient flakiness. A progressive delegation mechanism governs autonomous actions through a graduated autonomy model with trust scores computed from historical human approval patterns, denial-driven constraint learning, delegation templates, and chain-of-accountability logging. A deployment architecture comprising a cloud-hosted execution engine and an outbound-only customer-premises agent enables secure access to customer-side resources through a unified tool catalog.

Such embodiments disclosed herein can introduce four interconnected innovations that collectively transform automated testing from a reactive, human-directed activity into a proactive, autonomous capability.

The first innovation is an Application Context Model—a structured, self-building, and continuously updated knowledge base that represents the application under test. The system autonomously constructs this model by ingesting visual sources including test execution video recordings, design tool exports (e.g., Figma), application screenshots, documentation, and public/private available media. From these sources, the system extracts screen definitions with semantically identified interface elements, constructs a directed graph of screen transitions from temporal flow analysis, performs cross-language and cross-platform semantic unification to recognize logically equivalent screens across different locales and operating systems, and integrates external intelligence such as market statistics, device ecosystem data, and customer base information. The model further includes an intent layer that infers the business purpose and criticality of application screens and flows from requirements documentation, domain knowledge, user behavior patterns, and element naming semantics, enabling intent-informed test generation and risk assessment. The model updates incrementally as new observations occur, including observations from agentic test executions that detect discrepancies between the model and the current state of the application.

The second innovation is an Event-Driven Scenario Lifecycle that monitors a plurality of event sources—defect tracking systems, customer support channels, CI/CD pipelines, production monitoring, security advisory feeds, and the system's own execution results—and autonomously generates, executes, and manages test scenarios in response. When an event is received (e.g., a new defect report), the system parses the event content to extract a problem hypothesis, maps it to the Application Context Model, generates Natural Language Step Set (NLSS) scenarios to reproduce or validate the suspected problem, executes the scenarios with agentic exploration to refine problem understanding, classifies results, and takes appropriate action including updating the originating ticket, opening engineering defects, and adding scenarios to regression suites. The system maintains closed-loop defect lifecycle management where known defects actively influence execution behavior. Additionally, the system supports automated exploratory testing wherein the Application Context Model's screen graph is traversed algorithmically to identify untested paths, and agentic execution is employed to explore these paths, discovering new screens, elements, and transitions that update the model and generate candidate test scenarios.

The third innovation is a Self-Optimizing Test Analysis and Adaptive Infrastructure Management capability. This innovation comprises two interrelated components. The first component performs continuous analysis of the system's own execution results, external telemetry, incoming support tickets, and market data to identify patterns, anomalies, and trends using computational analysis methods including statistical analysis, machine learning, rule-based heuristics, and large language model-based interpretation. This analysis triggers autonomous corrective actions including targeted triage scenarios, mutation testing, device health management, test environment modification (including environment provisioning, database manipulation, and infrastructure scaling), performance test parameter adjustment based on production telemetry, and security validation in response to published vulnerability advisories. The second component introduces a coverage tier management system wherein named coverage tiers are defined as declarative policies comprising platform selection rules, market share thresholds, device reliability requirements, and attribute constraints. A resolution engine periodically resolves these policies against current analytics data to produce immutable, versioned tier snapshots—concrete device sets with full resolution rationale. Resolution is triggered by configurable schedules and by event triggers such as new operating system releases, device reliability breaches, or market share shifts. An intelligent test orchestration engine consumes tier snapshots to distribute test scenarios across devices using strategies appropriate to the tier's scope and budget, and performs diagnostic failure classification through structured retry sequences that distinguish genuine application defects from device-specific issues and transient execution flakiness.

The fourth innovation is an Autonomous Responsibility Agent with Progressive Delegation. The system operates with defined responsibility scopes (e.g., device lab management, defect triage, regression suite maintenance, coverage tier management), each with associated monitoring loops and data sources. A graduated autonomy model classifies potential actions into tiers based on impact and reversibility. A progressive trust learning mechanism computes trust scores from historical human approval and denial patterns, enabling the system to expand its autonomous authority over time. The mechanism includes denial-driven constraint learning, expedited approval pathways with auto-approve timeouts, and chain-of-accountability audit logging.

These innovations build upon the Natural Language Step Set (NLSS) framework described in the above referenced related application, which provides a platform-agnostic, multi-purpose test scenario abstraction expressed in natural language. The NLSS framework, enriched by the Application Context Model and triggered by the Event-Driven Scenario Lifecycle, enables a single natural language test definition to be deployed across mobile (iOS, Android), web, desktop, and other platforms, and to serve functional, performance, security, accessibility, UX, and synthetic monitoring purposes. The system further supports a deployment architecture comprising a cloud-hosted execution engine and a customer-premises agent connected via an outbound-initiated persistent connection, enabling agentic test execution to invoke customer-side resources (databases, internal APIs, environment management tools) through a unified tool catalog without requiring inbound network exposure from the customer.

Embodiments within the scope of the present disclosure include the following. It will be appreciated that a variety of other embodiments, not listed below, are also within the scope of the present disclosure.

One embodiment includes a computer-implemented method for autonomously constructing and maintaining an application context model for software testing, this method comprising: (a) ingesting from one or more sources, wherein the sources comprise at least one of: video recordings of application interactions, design tool exports, application screenshots, application documentation, publicly or privately available media, requirements documentation, and domain knowledge sources; (b) extracting screen definitions from the ingested sources, each screen definition comprising a screen identifier, a semantic description, a screen type classification, and a set of user interface element definitions, each element definition comprising at least an element type, a semantic name, and a natural language description; (c) constructing a directed graph of screen transitions from temporal flow analysis of video sources or structural analysis of design sources, wherein each transition edge associates a source screen, a target screen, and a triggering element or condition; (d) performing cross-language and cross-platform semantic unification to identify logically equivalent screens observed in different languages or on different platforms, the unification comprising structural comparison of element composition, semantic similarity of element names using multilingual language models, and transition graph topology comparison; (e) constructing an intent layer by inferring business purpose and criticality of screens and flows from one or more of: requirements documentation, domain knowledge, user behavior analytics, and element naming semantics; (f) integrating external intelligence comprising at least device ecosystem market data and customer base information into the application context model; and (g) incrementally updating the application context model as new observations from test executions, design updates, or external data refreshes become available, including comparing observed application state during agentic test execution against the model and flagging discrepancies as detected application changes.

In one or more further embodiments of this method, the sources comprise at least two of: video recordings, design tool exports, application screenshots, application documentation, publicly available media, requirements documentation, and domain knowledge sources. In one or more further embodiments of this method, extracting screen definitions from video recordings comprises: identifying distinct screens through visual change detection in the video; determining screen dwell times and transition points; identifying user interface elements within each screen using visual analysis; assigning semantic names and descriptions to identified elements; and recording appearance metadata including temporal position, duration, source execution identifier, platform, and device model. In one or more further embodiments of this method, the cross-language and cross-platform semantic unification further comprises visual similarity comparison of screen layouts when screenshots are available, and wherein identified equivalence links enable natural language test scenarios written against one locale or platform to be automatically adapted for execution on another locale or platform. In one or more further embodiments of this method, the method further comprises: when a source provides screen definitions without flow information, flagging the screens as having incomplete transition data; and invoking a human-in-the-loop process, managed through a progressive delegation mechanism, to supply missing transition information. In one or more further embodiments of this method, the intent layer assigns to screens and flows one or more of: a business purpose classification, a criticality rating, a regulatory sensitivity assessment, and a platform sensitivity assessment; and wherein the intent layer influences one or more of: test scenario generation priority, assertion selection, coverage tier allocation, and risk assessment for failure classification. In one or more further embodiments of this method, the external intelligence comprises market share data by device manufacturer, operating system version distribution, screen resolution prevalence, and regional device preferences; and wherein the method further comprises using the external intelligence to resolve natural language environment descriptions into specific device and configuration lists.

Another embodiment includes a computer-implemented method for event-driven test scenario generation and closed-loop defect lifecycle management, the method comprising: (a) monitoring, by a computing system, a plurality of event sources comprising at least one external event source selected from: defect tracking systems, customer support channels, CI/CD pipeline systems, production monitoring systems, and security advisory feeds; and incoming support tickets; and at least one internal event source derived from the system's own execution results or analysis; (b) upon receiving an event from a monitored source, parsing event content to extract a problem hypothesis expressed in natural language; (c) mapping the problem hypothesis to an application context model comprising a directed graph of application screens, user interface elements, screen transitions and an intent layer indicating business purpose and criticality, to identify relevant portions of the application; (d) generating one or more natural language test scenarios targeting the relevant portions of the application, the scenarios designed to reproduce or validate the suspected problem described in the problem hypothesis; (e) executing the generated scenarios using an agentic execution engine capable of dynamically generating additional scenario steps based on intermediate execution results to refine problem understanding; (f) classifying execution results and dispatching one or more actions including but not limited to: updating the originating event source with reproduction results, opening a defect record in an engineering tracking system, adding reproduction scenarios to a regression test suite, adjusting testing configuration; and modifying test environment configurations; (g) maintaining a defect record that includes execution behavior directives defining how the defect affects ongoing test execution; the directives communicated to a test orchestration engine to influence runtime execution decisions; and (h) upon detecting a defect status transition to resolved, automatically executing associated reproduction scenarios and, based on the results, either verifying and closing the defect record or reopening the defect with updated diagnostic information.

In one or more further embodiments of this method, the execution behavior directives comprise at least one of: marking test results exercising affected functionality as ‘known issue’ rather than ‘failure’; skipping execution of scenarios that are blocked by the defect; and continuing execution while collecting diagnostic data for defect resolution; and deprioritizing affected scenarios in orchestration distribution decisions. In one or more further embodiments of this method, generating natural language test scenarios comprises producing multiple scenario variants that explore different aspects of the problem hypothesis, including varying data patterns, platform configurations, and user flow paths. In one or more further embodiments of this method, the agentic execution engine refines the problem hypothesis based on intermediate results, and wherein refinement comprises: identifying conditions under which the suspected problem manifests; identifying conditions under which the suspected problem does not manifest; and generating a refined problem description that is more specific than the original hypothesis. In one or more further embodiments of this method, the method further comprises: identifying untested paths in the application context model's directed graph by comparing the graph against recorded test execution coverage; autonomously generating exploratory execution sequences that traverse the untested paths using agentic execution; updating the application context model with newly discovered screens, elements, and transitions encountered during exploratory execution; and generating candidate test scenarios from successful exploratory sequences. In one or more further embodiments of this method, the method further comprises: monitoring the system's own execution results as an internal event source, including: detecting statistically significant failure clusters across one or more dimensions including but not limited to platform, operating system version, device model, feature area, and time period; generating targeted investigation scenarios in response to detected clusters; and triggering corrective actions based on investigation results. In one or more further embodiments of this method, the method further comprises: monitoring production telemetry and adjusting performance testing parameters in response to changes in observed production usage patterns; and monitoring security advisory feeds and generating security validation scenarios when a published vulnerability is mapped to a component of the application's technology stack.

Another embodiment includes a computer-implemented method for dynamically managing test platform coverage through policy-based tier abstractions, the method comprising: (a) defining, by a computing system, one or more coverage tier policies, each policy comprising a tier identifier, a purpose classification, and one or more platform selection rules expressed as declarative constraints referencing one or more of: relative market position of operating system versions, market share thresholds, device reliability metrics derived from test execution history, device attribute requirements, manufacturer preferences, form factor constraints, and maximum device count budgets; (b) resolving each coverage tier policy against current data from one or more of: user analytics showing actual device distribution of application users, market share data from external sources, and device health metrics derived from test execution history, to produce a tier snapshot comprising a concrete set of device specifications satisfying the policy constraints; (c) triggering policy resolution based on one or more of: a configurable schedule, detection of a new operating system version reaching a significant adoption threshold, detection of a device reliability metric falling below a configurable threshold, detection of a market share shift exceeding a configurable threshold, and manual request; (d) generating a resolution rationale linking each device in the tier snapshot to the data that justified its inclusion or exclusion; (e) versioning each tier snapshot as an immutable artifact with change tracking relative to previous snapshots; and (f) making the tier snapshot available to a test orchestration engine for mapping scenario execution requests referencing a tier identifier to the resolved device set.

In one or more further embodiments of this method, coverage tier policies may be expressed in natural language descriptions that the system interprets using language model-based analysis and translates into structured policy rules, with the user reviewing and approving the structured interpretation. In one or more further embodiments of this method, the method further comprises: comparing actual test execution coverage against the tier snapshot composition and user base distribution to detect coverage gaps; and generating coverage gap signals that trigger one or more of: tier policy re-resolution, scenario generation targeting underrepresented platforms, and human notification.

Another embodiment includes a computer-implemented method for classifying test failures in distributed test execution, the method comprising: (a) executing, by a computing system, a test scenario on a first device selected from a coverage tier; (b) upon detecting a failure, performing a diagnostic retry sequence comprising: re-executing the scenario on the same first device to assess transient flakiness, and re-executing the scenario on a second device sharing platform attributes with the first device to assess device-specific failure; (c) computing a confidence classification for the failure based on the diagnostic retry results and historical execution data, the classification comprising a probability assessment across categories including at least: confirmed application defect, device-specific issue, and transient execution flakiness; (d) reporting the failure with the computed confidence classification, wherein only failures classified as confirmed application defects above a configurable confidence threshold are reported as actionable failures; and (e) feeding the classification results back into device health metrics that inform future coverage tier resolution and orchestration decisions.

In one or more further embodiments of this method, the method further comprises: distributing test scenarios across devices using one or more distribution strategies selected from: exhaustive distribution where every scenario executes on every device, distributed coverage where scenarios are allocated to subsets of devices ensuring collective coverage, and risk-weighted distribution where platform-sensitive scenarios receive broader device allocation based on information from an application context model. In one or more further embodiments of this method, the method further comprises: logging every orchestration decision including device selection rationale, distribution strategy choice, retry decisions, and runtime adjustments to an immutable audit trail, enabling full auditability of why any given test scenario executed on any given device.

Another embodiment includes a computer-implemented method for autonomous software testing management with progressive human-in-the-loop delegation, the method comprising: (a) defining, by a computing system, a plurality of responsibility scopes, each responsibility scope comprising a description of the responsibility, one or more monitoring loops defining data sources and monitoring frequencies, and a set of potential actions; (b) classifying each potential action into an autonomy tier selected from: auto-execute, expedited approval, and mandatory approval, based on at least the action's impact classification, reversibility assessment, and a computed trust score; (c) maintaining a delegation policy table with entries indexed by a composite key comprising at least action type and impact classification, each entry storing at least: cumulative approval count, cumulative denial count, time-weighted approval ratio, and a computed trust score; (d) computing the trust score from at least: historical approval patterns and the action's reversibility classification, wherein reversible actions accumulate trust at a faster rate than irreversible actions; (e) for auto-execute tier actions, executing the action autonomously, logging the action to an audit trail, and sending a notification to the designated authority; (f) for expedited approval tier actions, sending an approval request through a configured communication channel with a configurable auto-approve timeout, and proceeding with the action if no denial is received within the timeout period; (g) for mandatory approval tier actions, sending a detailed approval request and waiting for explicit human approval before proceeding; (h) upon receiving a denial for any action, resetting the trust score for the action's composite key to a configurable reset value and initiating a constraint capture process to record the denial reason as a constraint on future decisions; and (i) logging all actions, approvals, denials, and outcomes to an immutable audit trail.

In one or more further embodiments of this method, the method further includes: supporting delegation templates comprising predefined rules that pre-seed the delegation policy table and override trust score-based tier classification for matching actions, the templates encoding organizational policies regarding autonomous authority boundaries. In one or more further embodiments of this method, trust scores are subject to decay over time such that if an action type has not been exercised for a configurable period, its trust score gradually decreases, preventing stale autonomy for actions whose context may have changed. In one or more further embodiments of this method, the denial-driven constraint learning comprises: storing denial reasons as constraints associated with the action type; applying stored constraints as filters when evaluating future actions of the same type; and supporting time-bound constraints that expire automatically after a specified period. In one or more further embodiments of this method, the expedited approval mechanism further comprises: adaptively adjusting the auto-approve timeout duration based on the historical average response time of the approving authority and the urgency classification of the action. In one or more further embodiments of this method, the method further includes a reversibility assessment for each action type, wherein the trust score computation further considers the consistency of the approving authority's decisions and a minimum decision count requirement before trust may exceed the auto-execute threshold.

Another embodiment includes a system for executing test scenarios requiring access to both cloud-hosted and customer-premises resources, the system comprising: (a) a cloud-hosted execution engine comprising an agentic test execution module that interprets natural language test scenario steps; (b) a customer-premises agent configured to initiate and maintain an outbound persistent connection to the cloud-hosted execution engine, the agent hosting tool definitions describing operations available in the customer's environment; (c) a unified tool catalog accessible to the agentic test execution module, the catalog comprising tool definitions for cloud-native tools and customer-premises tools, each tool definition comprising an interface specification; (d) a routing layer that, upon receiving a tool invocation from the agentic test execution module, dispatches the invocation to either a cloud-native execution path or transmits the invocation to the customer-premises agent over the persistent connection based on tool routing metadata; and (e) wherein the customer-premises agent executes received tool invocations against local resources using locally-held credentials and returns results to the cloud-hosted execution engine without requiring inbound network connections to the customer premises.

In one or more further embodiments of this system, the customer-premises tools comprise one or more of: database query tools, internal API invocation tools, environment provisioning tools, and data sanitization tools.

Another embodiment includes a system for autonomous, context-aware, event-driven software testing, the system comprising: one or more processors; and memory storing instructions that, when executed, cause the system to: (a) autonomously construct and maintain an application context model from one or more visual and textual sources, the model comprising a directed graph of application screens with semantically identified user interface elements, screen transitions, cross-language equivalence links, an intent layer, and integrated external intelligence; (b) monitor a plurality of event sources and, in response to detected events, automatically generate natural language test scenarios by mapping event-derived problem hypotheses to the application context model; (c) execute generated scenarios using an agentic execution engine capable of dynamic step generation based on intermediate results; (d)maintain closed-loop defect lifecycle management wherein defect records include execution behavior directives and defect status transitions automatically trigger verification scenarios; (e) define coverage tier policies as declarative constraints and resolve them against current analytics data to produce versioned tier snapshots, with resolution triggered by configurable schedules and detected events; (f) distribute test scenarios across devices using an intelligent orchestration engine that performs diagnostic failure classification through structured retry sequences; (g) perform analysis of execution results, external data, and incoming events to detect failure patterns, coverage gaps, and device health issues, and autonomously generate corrective actions; and (h) govern all autonomous actions through a progressive delegation mechanism comprising a graduated autonomy model with trust scores computed from historical human approval patterns, denial-driven constraint learning, and chain-of-accountability audit logging.

In one or more further embodiments of this system, the application context model further supports automatic cross-language and cross-platform semantic unification using multilingual language models, enabling a single natural language test scenario to be executed across different platforms and language locales without modification. In one or more further embodiments of this system, the agentic execution engine employs a contextual caching mechanism for caching and reusing large language model results across test execution steps, as described in a co-pending related application. In one or more further embodiments of this system, the system further comprises: a customer-premises agent connected via an outbound-only persistent connection that enables the agentic execution engine to invoke customer-side tools through a unified tool catalog without requiring inbound network exposure from the customer.

Another embodiment includes a non-transitory computer-readable medium storing instructions that, when executed by one or more processors, cause the processors to perform a method comprising: (a) constructing an application context model by ingesting visual and textual sources to extract screen definitions, transition graphs, and an intent layer, performing cross-language semantic unification, and integrating external market and customer intelligence; (b) monitoring event sources including defect tracking systems, CI/CD pipelines, production monitoring, and incoming support tickets, and generating natural language test scenarios in response to detected events by mapping event content to the application context model; (c) defining coverage tier policies and resolving them against current analytics data to produce versioned tier snapshots; (d) executing scenarios with agentic exploration and intelligent orchestration including diagnostic failure classification through structured retry sequences; (e) maintaining closed-loop defect lifecycle management with execution behavior directives; (f) analyzing execution results to detect failure patterns, coverage gaps, and device health issues, and autonomously generating corrective actions including environment modification and infrastructure adjustment; and (g) governing autonomous actions through progressive delegation with trust scores, denial-driven constraint learning, and delegation templates.

Another embodiment includes a computer-implemented method for generating natural language test scenarios from multiple source types, the method comprising: (a) receiving, by a computing system, input from one or more source types selected from: user stories and epics, UX design tool exports, existing test scenarios, production user behavior analytics, production logs, video recordings, and application documentation; (b) parsing the input to generate a Natural Language Step Set (NLSS) comprising natural language-defined steps that encapsulate testing actions, wherein the NLSS preserves semantic intent without constraining step definitions to a programming language format; (c) generating from the NLSS one or more disposable, platform-specific test scripts for execution on a test grid, the scripts treated as ephemeral artifacts regenerated from the NLSS on demand; (d)executing the disposable scripts on the test grid and, upon detecting a fault during execution, reverting to an agentic AI execution module that re-interprets the original natural language step and recomputes the appropriate action; and (e) applying the NLSS scenario to multiple testing purposes selected from at least two of: functional testing, user experience testing, performance testing, security validation, accessibility auditing, and synthetic monitoring, without requiring manual scenario rework.

In one or more further embodiments of this method, the method further comprises: generating natural language descriptions of test data requirements and dynamically producing ephemeral test data sets from the descriptions using language model-based generation. In one or more further embodiments of this method, the method further comprises: generating natural language descriptions of environment requirements and dynamically resolving the descriptions into specific device and configuration lists.

### BRIEF DESCRIPTION OF THE DRAWINGS

FIG. 1 is a high-level system architecture block diagram showing the four innovation pillars and their interconnections: Application Context Model, Event-Driven Scenario Lifecycle, Self-Optimizing Test Analysis and Adaptive Infrastructure Management, and Autonomous Responsibility Agent with Progressive Delegation.

FIG. 2 is a block diagram illustrating an embodiment of the Application Context Model construction process, showing the ingestion of multiple visual and data sources, screen extraction, transition graph construction, cross-language/cross-platform semantic unification, intent layer construction, and external intelligence integration.

FIG. 3 is a block diagram illustrating a screen graph data structure embodiment, showing screen nodes with semantic element definitions, directed transition edges, appearance records with temporal and source metadata, and cross-language equivalence links.

FIG. 4 is a flow diagram illustrating an embodiment of the Event-Driven Scenario Lifecycle, showing the flow from event reception through problem hypothesis extraction, application context mapping, NLSS generation, agentic execution, result classification, and action dispatch.

FIG. 5 is a flow diagram illustrating an embodiment of the defect lifecycle management closed loop, showing how defect state transitions (open, in-progress, resolved, verified) affect test execution behavior and how test execution results feed back into defect state management.

FIG. 6 is a diagram illustrating an embodiment of the Self-Optimizing Test Analysis pipeline, showing analysis inputs (execution results, external telemetry, support tickets, market data), computational analysis methods, and the various corrective action pathways including mutation testing, device management, environment modification, and performance test adjustment.

FIG. 7 is a flow diagram illustrating an embodiment of the Autonomous Responsibility Agent architecture, showing responsibility scopes, monitoring loops (including test environment logging and infrastructure metrics), decision points, and the three-tier autonomy classification system.

FIG. 8 is a diagram illustrating an embodiment of the Progressive Delegation mechanism, showing the delegation policy table structure, trust score computation, tier transitions, denial-driven constraint learning, and delegation template integration.

FIG. 9 is a diagram illustrating an embodiment of the NLSS framework enhanced with Application Context, showing how context-aware and intent-informed NLSS generation differs from the context-free generation described in the provisional application.

FIG. 10 is a block diagram illustrating an embodiment of the multi-platform, multi-purpose execution architecture, showing how a single NLSS scenario is translated into platform-specific and purpose-specific execution through the agentic AI execution module and disposable script generation.

FIG. 11 is a diagram illustrating an example event-driven workflow: a defect report arrives from a bug tracking system, the system generates and executes reproduction scenarios, identifies the root cause, and completes the closed-loop defect lifecycle.

FIG. 12 is a diagram illustrating the trigger taxonomy, categorizing external triggers (defect reports, support tickets, CI/CD events, security advisories, market data changes) and internal triggers (execution result patterns, device health metrics, coverage gap detection, exploratory testing discoveries).

FIG. 13 is a flow diagram showing an embodiment of the full coverage tier resolution pipeline: policy at the top, four data sources feeding the resolution engine, immutable snapshots with progressive delegation gating, flowing down to the orchestrator and execution grid, with results feeding back to device health for the next resolution.

FIG. 14 is a flow diagram showing an embodiment of the diagnostic retry decision tree: initial failure→retry same device (if passes: transient flakiness)→retry different device with same attributes (if passes: device-specific)→cross-reference history→confidence classification→threshold gate→either report as actionable failure or log and update metrics.

FIG. 15 shows a block diagram of an embodiment of the deployment architecture: cloud side (left) has the execution engine, orchestrator, unified tool catalog, routing layer, and execution grid. Customer side (right) has the CI pipeline, customer tools, environment tools, and the agent. The outbound WebSocket connects them —initiated from the customer side, tool results flow back. No inbound exposure.

FIG. 16 is a flow diagram illustrating a second example workflow: coverage tier drift detection, automated tier resolution, intelligent orchestration of execution on updated device sets, diagnostic failure classification, and closed-loop corrective action.

### DETAILED DESCRIPTION

The following detailed description sets forth specific embodiments of the present invention. It should be understood that the invention is not limited to the particular embodiments described herein but encompasses all modifications, equivalents, and alternatives falling within the spirit and scope of the appended claims.

### I. System Architecture Overview

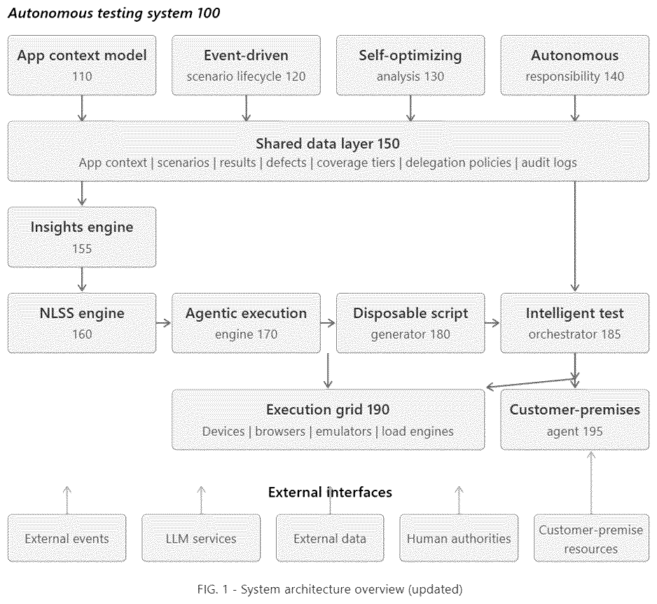

Referring now to FIG. 1, the autonomous testing system 100 comprises four interconnected subsystems: an Application Context Model subsystem 110, an Event-Driven Scenario Lifecycle subsystem 120, a Self-Optimizing Test Analysis and Adaptive Infrastructure Management subsystem 130, and an Autonomous Responsibility Agent subsystem 140. These subsystems communicate through a shared data layer 150 that maintains the application context, scenario definitions, execution results, defect records, coverage tier policies and snapshots, delegation policies, and audit logs.

The Self-Optimizing Test Analysis and Adaptive Infrastructure Management subsystem 130 generates internal trigger events that are processed by the Event-Driven Scenario Lifecycle subsystem 120 using the same event processing pipeline as external triggers. All action-generating decisions from subsystems 120, 130, and 110 are subject to the Progressive Delegation mechanism of subsystem 140. The Application Context Model subsystem 110 provides contextual grounding to all other subsystems, serving as the authoritative representation of the application under test.

The system further comprises an NLSS Engine 160 for natural language scenario generation and management, an Agentic Execution Engine 170 for interpreting and executing NLSS scenarios across platforms, a Disposable Script Generator 180 for producing ephemeral platform-specific test scripts, an Intelligent Test Orchestrator 185 for distributing test execution across devices and performing diagnostic failure classification, an Execution Grid 190 comprising physical devices, emulators, simulators, browsers, and other testing targets, and a Customer-Premises Agent 195 for secure, outbound-only bridging to customer infrastructure. The Agentic Execution Engine 170 may employ a contextual caching mechanism as described in the co-pending application referenced above.

An Insights Engine 155 serves as the sole strategic decision hub within the system. The Insights Engine 155 consumes analysis results from subsystem 130 and routes strategic actions to the appropriate targets: coverage gap signals to the NLSS Engine 160 for scenario generation, detected application changes to the Application Context Model 110 for model updates, actionable issues to external connectors for ticket creation or update, and runtime adjustment signals to the Intelligent Test Orchestrator 185. No other component independently initiates strategic changes to coverage tier definitions, scenario composition, or external system interactions; all such actions originate from or are routed through the Insights Engine 155.

### II. Application Context Model

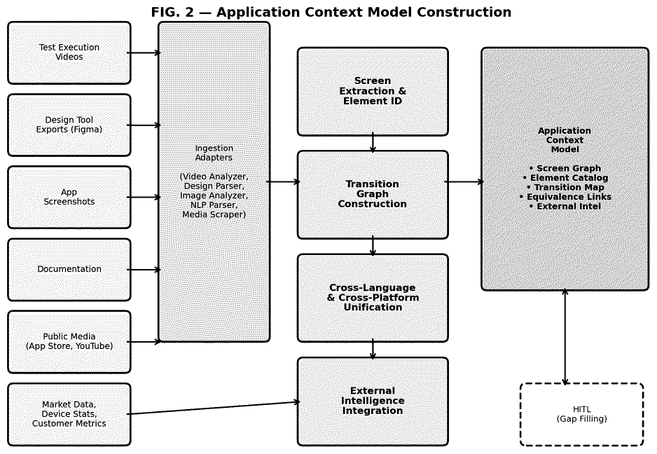

Referring now to FIG. 2, the Application Context Model subsystem 110 autonomously constructs and maintains a structured knowledge base that represents the application under test. The model comprises multiple interrelated components: a Screen Graph, an Element Catalog, a Transition Map, an Intent layer, an External Intelligence Store, and a Coverage Analysis Engine.

### A. Multi-Source Ingestion

The system ingests visual, textual, and contextual information about the application from a plurality of sources. These sources include, but are not limited to: video recordings of test executions on physical devices, emulators/simulators, desktop and browsers; design tool exports from platforms such as Figma, Sketch, or Adobe XD; application screenshots captured during manual or automated exploration; application documentation including user guides, API specifications, and release notes; publicly or privately available media including app store listings, promotional videos, and tutorial content; production user behavior analytics data; requirements documentation including user stories and epics; and domain knowledge sources including industry standards, regulatory requirements, and organizational documentation.

For each source type, a specialized ingestion adapter extracts relevant information. Video sources undergo temporal analysis to identify screen transitions, dwell times, and user interaction patterns. Design tool sources are parsed to extract screen layouts, component hierarchies, and, where available, predefined interaction flows. Static image sources are analyzed for screen content and UI element identification. Documentation sources are parsed using natural language understanding to extract descriptions of functionality, user flows, business rules, and intended purpose. Domain knowledge sources are analyzed to extract industry-specific testing requirements and compliance obligations.

### B. Screen Graph Construction

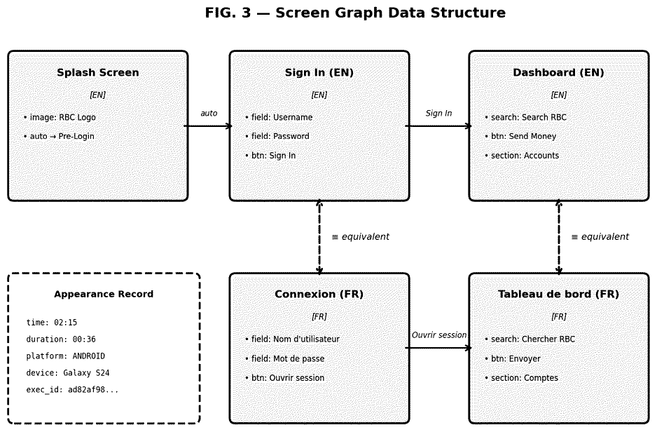

Referring now to FIG. 3, the system constructs a directed graph where nodes represent application screens and edges represent transitions between screens. Each screen node comprises: a unique screen identifier; a human-readable title; a semantic description of the screen's purpose; a screen type classification (full screen, overlay, popup, modal); a set of appearance records documenting when and where the screen was observed, including temporal position, duration, source execution identifier, platform, device model, and video reference; and an ordered list of UI element definitions.

Each UI element definition comprises: an element type (button, text field, dropdown, toggle, carousel, list, section, link, search bar, tab, image, or other); a semantic name describing the element's purpose; a natural language description of the element's function; format metadata where applicable (e.g., ‘password’, ‘numeric’, ‘alphanumeric’); column definitions for tabular elements; and visual clue descriptions that aid in locating the element during agentic execution (e.g., ‘Blue full-width button at the bottom’, ‘Magnifying glass icon’).

Each transition edge comprises: the source screen identifier; the target screen identifier; and the triggering element or condition (e.g., a specific button, an automatic transition, or a system event). Transitions may be conditional—the same triggering element may lead to different target screens depending on application state, as observed across multiple appearances.

### C. Cross-Language and Cross-Platform Semantic Unification

A critical capability of the Application Context Model is the automatic unification of logically equivalent screens observed across different languages, locales, and platforms. When the system observes a screen in one language (e.g., English: ‘Sign In’) and another screen in a different language (e.g., French: ‘Ouvrir une session’), it applies semantic matching to determine whether these represent the same logical screen.

The semantic matching process comprises: structural comparison of the screen's element composition (number, types, and arrangement of elements); semantic similarity of element names and descriptions using multilingual language models; transition graph topology comparison (screens that connect to the same upstream and downstream screens are more likely to be equivalent); and visual similarity of screen layout and element positioning when screenshots are available.

When two screens are identified as logically equivalent, the system creates an equivalence link that allows NLSS scenarios written against one locale or platform to be automatically adapted for execution on the other. This cross-language and cross-platform unification is performed automatically using large language model-based semantic analysis without requiring manual mapping.

### D. Intent Layer

The Application Context Model includes an intent layer that infers the business purpose and criticality of application screens and flows. The intent layer is constructed by analyzing: requirements documentation and user stories that describe intended functionality; domain knowledge about the application category (e.g., a banking application is understood to have security-critical authentication flows and financially regulated transaction flows); user behavior analytics patterns that reveal which flows are most frequently used and which are abandoned; element naming semantics and descriptions that convey purpose (e.g., a field named ‘Password’ with format ‘password’ on a screen titled ‘Sign In’ conveys authentication intent); and, where available, organizational documentation including team communications, design rationale, and published materials that describe product strategy and priorities.

The intent layer assigns to each screen and flow: a business purpose classification (e.g., authentication, transaction, navigation, settings, onboarding); a criticality rating derived from business purpose and usage frequency; a regulatory sensitivity assessment where applicable (e.g., payment flows subject to PCI compliance, personal data flows subject to privacy regulations); and a platform sensitivity assessment indicating whether the screen or flow is likely to behave differently across platforms based on its element composition and interaction patterns.

The intent layer influences multiple downstream processes: test scenario generation prioritizes high-criticality flows; assertion selection is guided by the business purpose (authentication flows verify access control, transaction flows verify amounts and confirmations); coverage tier allocation weights platform-sensitive flows for broader device distribution; and risk assessment for failure classification considers business criticality when evaluating failure severity.

### E. External Intelligence Integration

The Application Context Model integrates external data sources to enrich the testing context. These sources include: application marketplace data (ratings, reviews, download counts, competitive positioning) gathered from app stores and analytics platforms; company and industry information including company size, geography, customer base, and regulatory environment; device ecosystem data including market share by manufacturer, operating system version distribution, screen resolution prevalence, and regional device preferences; customer metrics including total users, active mobile users, active web users, and estimated concurrent usage patterns; and scale requirements derived from the above, including load testing targets, performance SLAs, and stress test thresholds.

This external intelligence is periodically refreshed and is used by the NLSS generation engine to produce contextually appropriate test scenarios, data sets, and environment configurations, and by the coverage tier resolution engine to resolve tier policies into concrete device sets.

### F. Incremental Model Updates and Execution Feedback

The Application Context Model is not a static artifact but a living representation that updates incrementally. Each new test execution, design update, or external data refresh triggers an update cycle. The system compares newly observed screens against existing screen definitions using visual and semantic similarity. New screens are added to the graph; existing screens are updated with new appearance records, newly observed elements, and newly observed transitions. Each screen maintains a last-update timestamp and a provenance record tracking all observations that contributed to its current definition.

Additionally, during agentic test execution, the execution workers continuously compare the observed application state against the Application Context Model. When a worker encounters a screen that differs from the model—for example, a new element has appeared, an element has moved, or the screen layout has changed—this discrepancy is flagged as a detected application change. Detected changes are routed through the Insights Engine, which may trigger a model update, flag affected scenarios for review, or generate targeted verification scenarios to assess the scope of the change. This mechanism turns every test execution into an implicit Application Context maintenance cycle.

When flow information is unavailable from a static source (e.g., a design document that shows screens but not their interconnections), the system flags these screens as having incomplete transition data and optionally invokes a human-in-the-loop (HITL) process to supply the missing transition information. As described in Section V, the HITL interactions are managed through the progressive delegation mechanism.

### III. Event-Driven Scenario Lifecycle

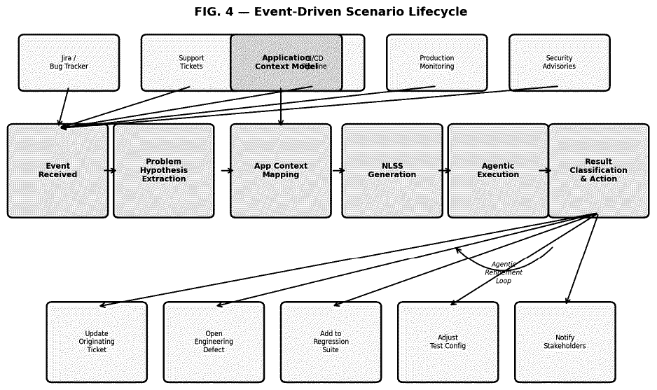

Referring now to FIG. 4, the Event-Driven Scenario Lifecycle subsystem 120 monitors a plurality of event sources and autonomously generates, executes, and manages test scenarios in response to relevant events.

### A. Trigger Taxonomy

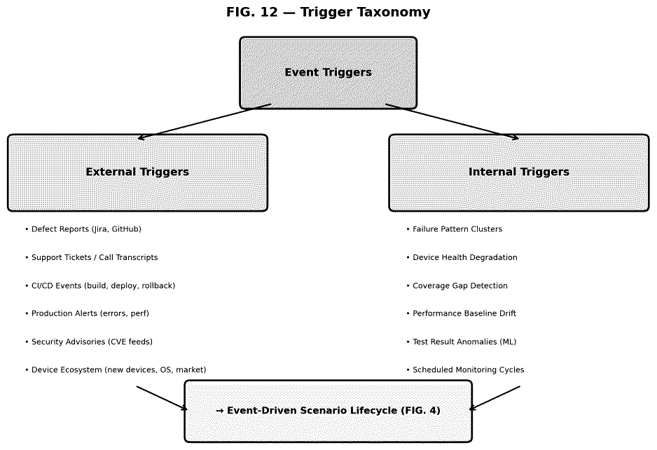

Referring now to FIG. 12, the system defines a comprehensive trigger taxonomy comprising external triggers and internal triggers.

External triggers include: defect reports from bug tracking systems (e.g., Jira, Azure DevOps, GitHub Issues), where a new or updated defect report triggers scenario generation to reproduce the reported issue; customer support interactions (e.g., support tickets, call transcripts) that describe user-facing problems; CI/CD pipeline events (e.g., new build available, deployment completed, rollback initiated) that trigger regression or smoke testing; production monitoring alerts (e.g., error rate spikes, performance degradation, service outages) that trigger diagnostic scenario generation; security advisory feeds (e.g., CVE publications, dependency vulnerability reports) that trigger security validation scenario generation for affected components; and device ecosystem changes (e.g., new device model released, operating system version published, market share shifts) that trigger coverage tier re-resolution and environment updates.

Internal triggers include: execution result patterns identified by the Self-Optimizing Test Analysis subsystem (Section IV), such as failure clustering by platform, version, or feature area; device health metrics indicating that a specific device in the test lab is producing unreliable results; coverage gap detection when the system identifies areas of the Application Context Model that lack test coverage or when coverage tier analysis reveals underrepresented platforms; exploratory testing discoveries when automated exploration reveals previously unknown application paths; and scheduled monitoring cycles for periodic reassessment of external data sources and coverage tier policies.

### B. Event Processing Pipeline

When an event is received, the system processes it through a multi-stage pipeline. In the first stage, the event content is parsed to extract a structured problem hypothesis. For a defect report, this involves analyzing the defect title, description, steps to reproduce (if provided), and any attached artifacts (screenshots, logs) to formulate a natural language hypothesis such as ‘Users are unable to log in when the username contains special characters.’ For a security advisory, this involves mapping the vulnerability to affected application components and formulating a hypothesis such as ‘The application's use of library X version Y may be vulnerable to injection attack Z.’

In the second stage, the problem hypothesis is mapped to the Application Context Model. The system identifies which screens, elements, and transitions are relevant to the hypothesis, and uses the intent layer to assess the criticality and platform sensitivity of the affected functionality. For the login example, the system would identify the login screen, the username input field, the sign-in button, and the subsequent authentication flow in the screen graph, and recognize from the intent layer that this is a security-critical authentication flow.

In the third stage, the system generates one or more NLSS scenarios designed to reproduce or validate the suspected problem. The NLSS generation leverages the Application Context Model to produce scenarios that navigate to the relevant screens, interact with the relevant elements, and validate the expected behavior. The system may generate multiple scenario variants to explore different aspects of the problem hypothesis (e.g., special character at the beginning of the username, in the middle, at the end, and various special character types).

In the fourth stage, the generated scenarios are executed using the Agentic Execution Engine, with distribution managed by the Intelligent Test Orchestrator. During execution, the system may employ agentic exploration—dynamically generating additional NLSS steps based on intermediate results to refine the problem understanding. For example, if the initial hypothesis is ‘username contains special character X causes failure,’ but execution reveals that ‘X’ in the middle of the username works correctly while ‘X’ at the beginning fails, the system refines the hypothesis and generates additional scenarios to confirm the refined understanding.

In the fifth stage, results are classified and appropriate actions are dispatched through the Insights Engine. Actions include: updating the originating event source (e.g., adding reproduction results as comments on the defect report, including references to the executed scenarios and captured evidence); opening a new engineering defect if the issue is confirmed but no engineering ticket exists; adding the reproduction scenario to a regression test suite for ongoing monitoring; adjusting testing configuration (e.g., adding specific data patterns to the test data pool); and modifying test environment configurations where applicable. All external-facing actions are subject to the progressive delegation mechanism described in Section V.

### C. Defect Lifecycle Management

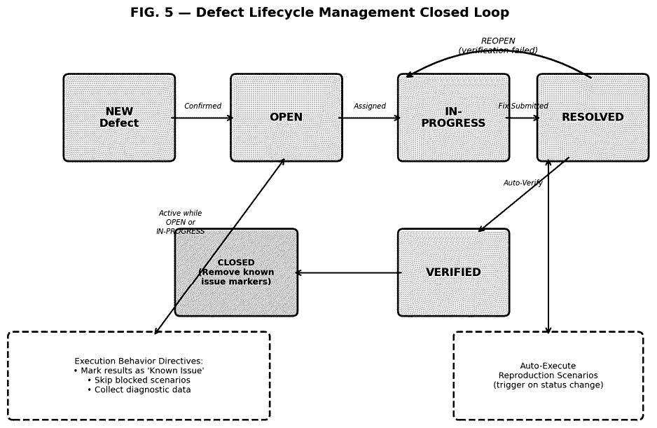

Referring now to FIG. 5, the system maintains a closed-loop defect lifecycle that actively influences test execution behavior. When a defect is identified and confirmed, the system creates or updates a defect record in the shared data layer. This defect record includes: the defect identifier in the external tracking system; the natural language problem description; references to reproduction NLSS scenarios; affected screens and elements in the Application Context Model; current defect status (open, in-progress, resolved, verified); and execution behavior directives.

Execution behavior directives define how the defect affects ongoing test execution. When a defect is in ‘open’ or ‘in-progress’status, the system may: mark test results that exercise the affected functionality as ‘known issue’ rather than ‘failure,’ preventing false alarm noise in test reporting; skip execution of specific scenarios that are blocked by the defect, when the defect prevents meaningful completion of the scenario; or continue executing and collect diagnostic data for the defect's resolution effort. Known defect records are also communicated to the Intelligent Test Orchestrator, which uses them to make runtime execution decisions: scenarios exercising known-defect functionality may be deprioritized in distribution, specifically targeted for verification runs, or annotated in results to distinguish known failures from new discoveries.

When a defect transitions to ‘resolved’ status in the external tracking system, the system automatically triggers execution of the associated reproduction scenarios to verify the fix. If the scenarios now pass, the system transitions the defect record to ‘verified’ status and removes the execution behavior directives. If the scenarios still fail, the system automatically reopens the defect in the external tracking system with updated diagnostic information, and the execution behavior directives remain in effect.

### D. Automated Exploratory Testing

The system supports automated exploratory testing wherein the Application Context Model's screen graph is traversed algorithmically to identify untested paths—transitions and screen states that have not been exercised by any existing test scenario. The system employs agentic execution to navigate these untested paths, using the screen graph for navigation guidance and the intent layer for prioritization (high-criticality untested paths are explored first).

During exploratory execution, the system may discover new screens, elements, or transitions not previously represented in the Application Context Model. These discoveries are recorded and used to update the model. Successful exploratory paths—those that complete without encountering application errors—are converted into candidate NLSS scenarios. Exploratory paths that reveal application errors generate internal triggers for the event processing pipeline.

Candidate scenarios generated through exploratory testing are subject to the progressive delegation mechanism for review and approval before addition to regression suites. Over time, as the system demonstrates the quality of its exploratory scenario generation, trust scores for this action type may increase, enabling automatic addition with reduced human oversight.

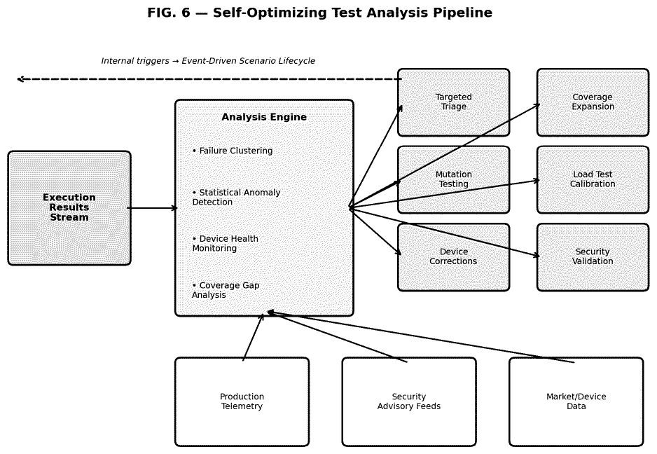

IV. Self-Optimizing Test Analysis and Adaptive Infrastructure Management Referring now to FIG. 6, the Self-Optimizing Test Analysis and Adaptive Infrastructure Management subsystem 130 performs continuous analysis of the system's execution results, external telemetry, incoming support tickets, market data, and other data sources to identify patterns, anomalies, and optimization opportunities. This subsystem generates internal triggers that feed back into the Event-Driven Scenario Lifecycle and provides strategic action recommendations that are routed through the Insights Engine.

### A. Failure Pattern Detection

The system performs multi-dimensional clustering and analysis of test failures across dimensions including, but not limited to: platform (iOS, Android, Windows, Linux), operating system version, browser versions, device manufacturer and model, screen resolution, geographic location, feature area (mapped to the Application Context Model), time of day, test data characteristics, and incoming support ticket patterns. Analysis is performed using computational methods including statistical analysis, machine learning, rule-based heuristics, large language model-based interpretation, and trend analysis. The system is not limited to any particular analysis technique.

When a significant pattern is identified (e.g., ‘iOS 17 failure rate is 3x higher than iOS 18 for login scenarios,’ or ‘support ticket volume for payment failures has increased 200% this week’), the system generates an internal trigger that initiates targeted investigation.

Investigation may take the form of: expanded scenario generation to isolate the root cause (e.g., generating additional login scenarios with different data patterns specifically targeting iOS 17); mutation testing to determine whether the failures represent genuine defects or test fragility; cross-reference with the Application Context Model to identify whether the affected screens have platform-specific element definitions or transition behaviors; and correlation with incoming support tickets or production monitoring data to assess real-world impact.

### B. Device Health Monitoring

The system continuously monitors the health and reliability of devices in the execution grid. For each device, the system tracks metrics including: execution success rate, blocked execution rate (indicating device unavailability or instability), average execution time relative to the device class, frequency of inconclusive or unknown results, and historical trend of these metrics over configurable time windows.

When a device's health metrics fall below configurable thresholds, the system may: remove the device from the active execution pool; generate a support request for device reset or replacement; redistribute the device's test allocation to other devices in the same class; notify the responsible human through the progressive delegation mechanism; and update the device's reliability score in the shared data layer so that future coverage tier resolutions reflect the device's degraded status.

### C. Coverage Tier Management

The system introduces a coverage tier management system that abstracts device selection from static lists to dynamic, policy-driven compositions. This section describes the tier definition, resolution, and lifecycle management mechanisms.

### C.1 Coverage Tier Policy Definition

A coverage tier is a named, reusable abstraction representing a set of platform selection rules and constraints. Each tier policy comprises: a tier identifier and human-readable name (e.g., ‘sanity’, ‘nightly’, ‘full-regression’); a purpose classification that influences execution strategy; and one or more platform selection rules.

Platform selection rules are expressed as declarative constraints that may reference: relative market position of operating system versions (e.g., ‘top N versions by user base share’ or ‘all versions with greater than M % adoption’); device manufacturer preferences (e.g., ‘top N manufacturers’or specific named manufacturers); device performance tier requirements (e.g., flagship, mid-range, low-end); form factor constraints (e.g., phone, tablet, foldable); screen resolution categories; minimum device reliability scores derived from execution history; maximum total device count budgets; and regional or geographic device preferences.

Tier policies may be defined through natural language descriptions that the system interprets using large language model-based analysis and translates into structured policy rules. For example, a natural language description such as ‘test on flagship phones from the top 3 manufacturers, covering the 2 most popular iOS and 3 most popular Android versions among our Canadian users, excluding any device with less than 95% reliability’ is translated into a structured set of constraints. The user reviews and approves the structured interpretation, ensuring that the policy captures the intended coverage strategy. Alternatively, tier policies may be defined directly as structured rules. This dual-input approach provides flexibility in definition while maintaining determinism in resolution.

### C.2 Policy Resolution Engine

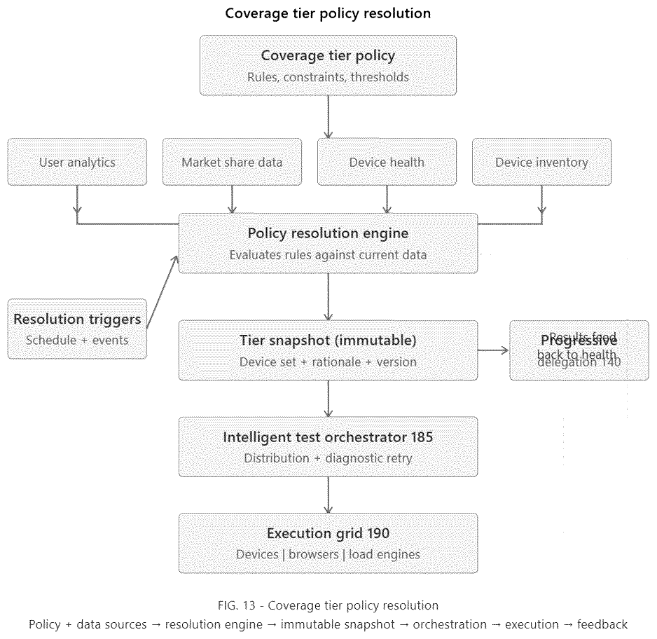

Referring now to FIG. 13, the system includes a policy resolution engine that periodically resolves tier policies against current data to produce tier snapshots. The resolution engine consumes data from multiple sources: first-party user analytics from connected analytics platforms (e.g., Firebase, Mixpanel) showing the actual device, operating system, and browser distribution of the application's users; market share data from external data providers showing broader device ecosystem trends; device health metrics from the system's own execution history; and device inventory data reflecting currently available devices in the execution grid.

The resolution engine evaluates each platform selection rule against the current data and computes a set of devices that satisfies all constraints. When constraints conflict (e.g., the top 3 manufacturers by market share do not include a manufacturer with the highest reliability), the resolution engine applies a priority ordering defined in the tier policy or uses a default priority that favors market coverage over other constraints.

Each resolution produces a tier snapshot—an immutable, versioned artifact comprising: the resolved device set with full device attributes; the resolution timestamp; the trigger type that initiated resolution (scheduled, event-driven, or manual); a resolution rationale linking each selected device to the data that justified its inclusion or exclusion; a reference to the previous snapshot for the same tier; and a change log describing additions, removals, and substitutions relative to the previous snapshot.

### C.3 Resolution Triggers

Tier policy resolution is triggered by one or more of: a configurable schedule (e.g., weekly, monthly); detection of a new operating system version reaching a significant adoption threshold in user analytics or market data; detection of a device reliability metric falling below the threshold specified in the tier policy; detection of a market share shift exceeding a configurable threshold for a device category included or excluded from the tier; and manual request by a human operator.

When resolution is triggered, the new snapshot is subject to the progressive delegation mechanism before becoming active. For the initial deployment, snapshot changes may require human approval. As the system demonstrates the quality of its resolution decisions through consistent human approval, trust scores for tier resolution actions may increase, enabling automatic snapshot activation with notification.

### C.4 Market-Weighted Coverage Analysis

The system compares actual test execution coverage against both the Application Context Model and the current tier snapshot composition to identify coverage gaps. Coverage analysis operates at multiple levels: screen coverage (which screens in the model have been exercised by tests); element coverage (which elements on each screen have been interacted with); transition coverage (which navigation paths have been exercised); platform coverage (which platforms and OS versions have been tested); and market-weighted coverage (how well the tested device mix aligns with actual user base distribution from the connected analytics sources).

When the system detects that tested devices diverge significantly from market reality or user base distribution, it generates a coverage gap signal that is routed through the Insights Engine, which may trigger tier policy re-resolution, scenario generation targeting underrepresented platforms, or human notification.

### D. Performance Test Calibration

The system monitors production telemetry (when available) to calibrate performance testing parameters. When production metrics indicate that peak concurrent usage has changed (e.g., grown from 5 million to 10 million concurrent users), the system automatically adjusts load testing targets to maintain an appropriate safety margin (e.g., testing at 150% of observed peak). Similarly, when production response time distributions change, the system adjusts performance assertions in NLSS scenarios to reflect updated baselines.

### E. Security Vulnerability Response

The system monitors security advisory feeds and maintains a mapping between the application's technology stack (as understood from the Application Context Model and supplementary configuration) and published vulnerabilities. When a relevant vulnerability is identified (e.g., a CVE affecting a specific version of a library used by the application), the system generates security validation NLSS scenarios that specifically target the vulnerability's attack vector within the application's context.

### F. Corrective Action Framework

The system supports a comprehensive set of corrective actions that may be triggered by analysis findings, coverage gap detection, or other internal triggers. Corrective actions include, but are not limited to: generating targeted test scenarios for investigation or expanded coverage; modifying coverage tier policies or triggering tier re-resolution; modifying the test environment including environment provisioning, vertical or horizontal scaling, database manipulation (including data masking, snapshotting, and sanitization using connected tools), and configuration changes (feature flags, environment variables); adjusting device allocation within the execution grid; generating support requests or procurement requests for new devices; creating or updating tickets in external tracking systems; and notifying relevant stakeholders through configured communication channels.

All corrective actions are subject to the progressive delegation mechanism described in Section V. Actions that interact with customer-premises resources (e.g., database manipulation, environment provisioning) are executed through the customer-premises agent described in Section VI.E.

### IV-A. Intelligent Test Orchestration

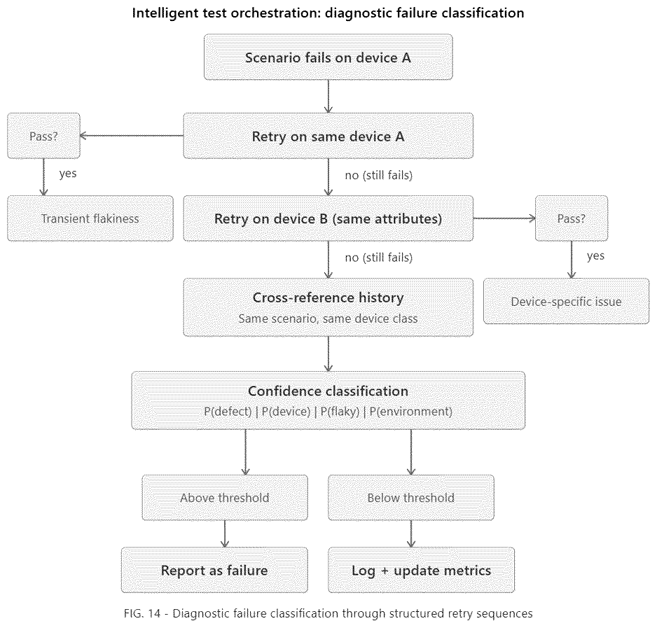

Referring now to FIG. 14, the Intelligent Test Orchestrator 185 receives execution requests, computes optimal distribution of test scenarios across available devices, manages execution in real-time, and performs diagnostic failure classification. The orchestrator sits between content definition (scenarios, suites, and coverage tier snapshots) and execution (agentic workers and the device grid).

### IV-A.1. Orchestration Architecture

The orchestrator receives execution commands comprising a reference to a scenario suite and a coverage tier (or explicit device specification). Upon receiving a command, the orchestrator: resolves the coverage tier reference to the current tier snapshot; retrieves the scenario definitions from the shared data layer; consults the platforms database for live device availability and current health metrics; retrieves known issue records that may affect execution; and computes a distribution plan mapping specific scenarios to specific devices.

The orchestrator logs every decision—device selection rationale, distribution strategy choice, and any adjustments made during execution—to an immutable audit trail. This enables full auditability: for any test result, a user can determine why that scenario ran on that specific device, whether any retries occurred, and what data informed the orchestrator's decisions.

### IV-B. Distribution Strategies

The orchestrator selects a distribution strategy based on the tier's scope, the number of scenarios, the number of available devices, and configurable execution budget constraints.

Exhaustive distribution (all-on-all): Every scenario in the suite executes on every device in the tier snapshot. This strategy is appropriate for small coverage tiers (e.g., a sanity tier with 5 devices) where the multiplicative cost is manageable and maximum platform coverage per scenario is desired.

Distributed coverage: Each scenario executes on a subset of devices, but the orchestrator ensures that collectively, all devices in the tier snapshot receive execution across the full scenario set. The distribution algorithm balances device utilization, accounts for device health and availability, and ensures that no device is systematically underrepresented. This strategy is appropriate for medium-to-large tiers where exhaustive distribution exceeds the execution budget.

Risk-weighted distribution: The orchestrator uses information from the Application Context Model's intent layer and historical execution data to allocate more device variety to platform-sensitive scenarios. Scenarios that exercise UI-intensive flows, platform-specific features, or flows with historical platform-divergent behavior are allocated to more devices, while platform-agnostic scenarios (e.g., API validations) may be allocated to fewer devices. This strategy optimizes coverage value per execution.

The orchestrator may combine strategies within a single execution: for example, applying exhaustive distribution to a high-priority scenario subset while applying distributed coverage to the remainder.

### IV-C. Diagnostic Failure Classification

When a test scenario fails during execution, the orchestrator performs a diagnostic retry sequence before reporting the failure. This sequence is designed to classify the failure with a confidence assessment across multiple categories.

Upon initial failure of a scenario on a first device, the orchestrator: re-executes the scenario on the same first device to assess whether the failure is transient (a passing retry indicates transient flakiness); re-executes the scenario on a second device sharing the same platform attributes (operating system version, form factor) as the first device to assess whether the failure is device-specific (a passing result on the second device indicates a device-specific issue); and cross-references the failure with historical execution data for the same scenario and device class to assess whether this failure pattern has been previously observed.

Based on the retry results and historical data, the orchestrator computes a confidence classification comprising a probability assessment across categories including: confirmed application defect (failure reproduces across multiple devices and retries), device-specific issue (failure occurs only on the specific device), transient execution flakiness (failure does not reproduce on retry), and environment or data issue (failure pattern correlates with known data or environment states).

Only failures classified as confirmed application defects above a configurable confidence threshold are reported as actionable failures. Other failure classifications are logged, contribute to device health metrics, and may generate internal triggers for investigation but do not produce false-positive failure signals in test reporting. This mechanism directly addresses the “shadow testing loop” problem described in the Background by reducing the false failure rate that causes teams to ignore CI regression results.

### IV-D. Execution Monitoring and Real-Time Adjustment

During execution, the orchestrator monitors progress and makes real-time tactical adjustments. If a device becomes unavailable mid-execution, pending scenarios are redistributed to other available devices with compatible attributes. If an emerging failure pattern is detected across multiple scenarios on the same device, the orchestrator may proactively deprioritize remaining scenarios on that device and redistribute them. Known issue records received during execution (e.g., a defect is marked as ‘open’ in the external tracking system while tests are running) are incorporated in real-time, with affected test results annotated accordingly.

### IV-E. Deployment Architecture

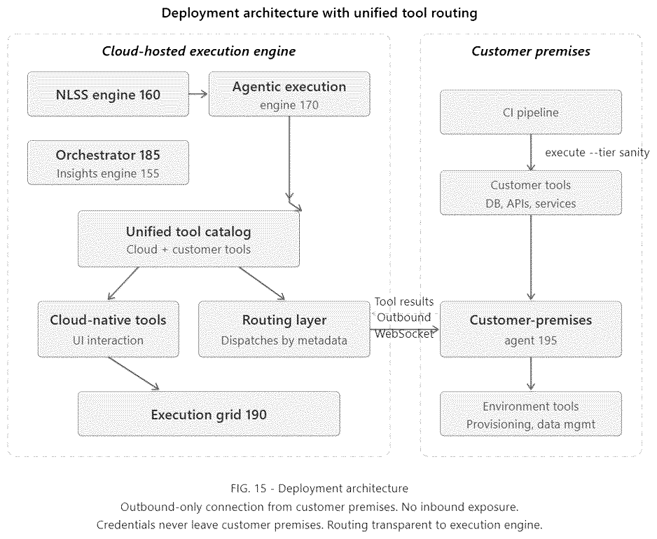

Referring now to FIG. 15, the system supports a deployment architecture that enables secure access to customer-premises resources without requiring inbound network exposure.

The deployment comprises: a cloud-hosted execution engine that includes the Agentic Execution Engine, Intelligent Test Orchestrator, Insights Engine, and all cloud-native components; and a customer-premises agent that is deployed within the customer's infrastructure.

The customer-premises agent initiates and maintains an outbound persistent connection (e.g., WebSocket) to the cloud-hosted execution engine. No inbound network connections, exposed endpoints, or firewall rule changes are required on the customer side. The agent is a lightweight relay that: hosts customer-defined tool definitions describing operations available in the customer's environment (database queries, internal API calls, service invocations); hosts integrations with environment management tools (e.g., tools for environment provisioning, data sanitization, configuration management); receives tool-call requests from the cloud execution engine via the outbound connection; executes requested tool operations against local resources using locally-held credentials (credentials never leave the customer premises); and returns operation results to the cloud execution engine.

The system maintains a unified tool catalog accessible to the Agentic Execution Engine. This catalog comprises tool definitions for both cloud-native tools (device interaction, screen capture, UI element manipulation) and customer-premises tools. Each tool definition includes an interface specification (parameters, return types, timeout), a routing classification (cloud-native or customer-premises), and an optional security scope designation.

When the Agentic Execution Engine requires a tool operation during scenario execution, it invokes the tool through the unified catalog without distinction between cloud-native and customer-premises tools. A routing layer examines the tool's routing classification and dispatches the invocation accordingly: cloud-native tools execute within the cloud environment, and customer-premises tools are transmitted to the customer-premises agent over the persistent connection for local execution.

This architecture enables natural language test scenarios to include backend verification steps (e.g., ‘verify that the user's account balance in the database matches the balance displayed on the dashboard’) without requiring the cloud execution engine to have direct network access to the customer's database. The LLM-based execution engine reasons about which tool to invoke based on the scenario step's intent, and the routing is transparent to the execution logic.

### V. Autonomous Responsibility Agent with Progressive Delegation

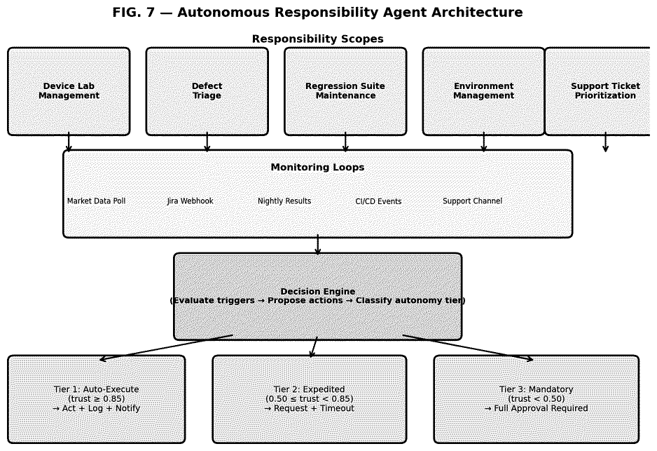

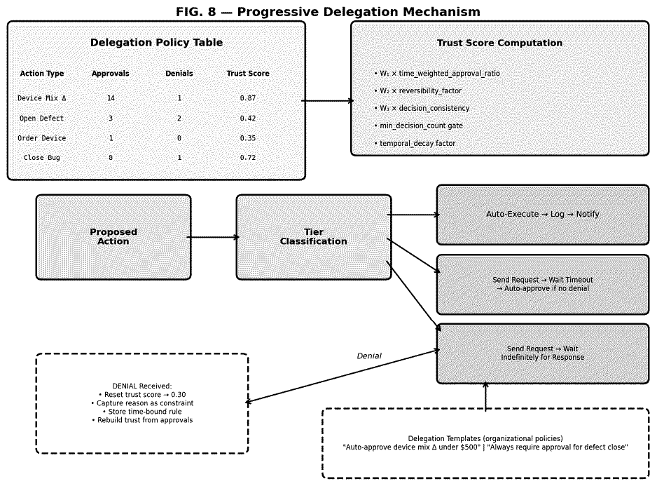

Referring now to FIG. 7 and FIG. 8, the Autonomous Responsibility Agent subsystem 140 provides the governance and decision-making framework within which the other subsystems operate. This subsystem enables the system to function as an autonomous agent with defined responsibilities while maintaining appropriate human oversight.

### A. Responsibility Scopes

The system defines a set of responsibility scopes, each comprising: a natural language description of the responsibility (e.g., ‘Maintain device lab coverage aligned with market share data’, 'Triage incoming support tickets by generating reproduction scenarios', ‘Maintain regression test suite currency’, ‘Manage coverage tier resolution and updates’); one or more associated monitoring loops that define what data sources the responsibility monitors (including execution results, test environment logs, infrastructure metrics, external data feeds) and at what frequency; a set of potential actions that may be taken in service of the responsibility; and autonomy parameters that govern how much authority the system has to act independently within the responsibility scope.

### B. Graduated Autonomy Model

Each potential action within a responsibility scope is classified into one of three autonomy tiers based on the action's impact, reversibility, and the system's accumulated trust for that action type.

Tier 1 (Auto-Execute): Actions whose trust score exceeds a configurable upper threshold (e.g., 0.85). The system takes the action autonomously, logs it to the audit trail, and sends a notification to the designated human authority. No approval is requested. Examples include: activating a new coverage tier snapshot that adds or substitutes devices without changing the total count; marking a test result as ‘known issue’ for an open defect; orchestration tactical decisions such as diagnostic retries and device redistribution (which are reversible and low-impact by nature); and adding a generated reproduction scenario to a regression suite.

Tier 2 (Expedited Approval): Actions whose trust score falls between the lower and upper thresholds (e.g., between 0.50 and 0.85). The system generates an approval request and sends it through a configured communication channel (e.g., Slack message, email). The request includes a configurable auto-approve timeout (e.g., 4 hours). If the human does not respond within the timeout period, the action proceeds. If the human denies the action, the denial is recorded and processed as described in subsection D. Examples include: removing an unstable device from the active execution pool; closing a defect that has been verified as fixed; adjusting load testing parameters based on production telemetry; activating a coverage tier snapshot that significantly changes the device composition.

Tier 3 (Mandatory Approval): Actions whose trust score falls below the lower threshold (e.g., below 0.50) or that are classified as high-impact regardless of trust score. The system generates a full approval request with detailed justification and waits indefinitely for human response. No timeout applies. Examples include: ordering physical devices for the test lab; opening an engineering defect in the external tracking system for the first time; modifying production monitoring thresholds; making significant changes to coverage tier policies.

### C. Progressive Trust Learning

Referring now to FIG. 8, the system maintains a delegation policy table with entries indexed by a composite key comprising: action type, impact classification, requesting responsibility scope, and approving authority. Each entry maintains: a cumulative approval count; a cumulative denial count; a time-weighted approval ratio (recent decisions are weighted more heavily than older ones); average human response time; most recent denial reason (if any); and a computed trust score.

The trust score is computed using a weighted formula that considers: the time-weighted approval ratio as the primary factor; the action's reversibility classification (reversible actions accumulate trust faster because the consequences of autonomous error are lower); the consistency of the approving authority's decisions (erratic approval patterns slow trust accumulation); and the total number of decisions (a minimum decision count is required before trust can exceed the Tier 2 threshold, preventing premature auto-execution from a small sample).

Trust scores are recalculated after each human decision and are subject to decay over time—if a particular action type has not been exercised for a configurable period, its trust score gradually decreases, ensuring that the system does not maintain stale autonomy for actions whose context may have changed.

### D. Denial-Driven Constraint Learning

When a human denies an action, the system initiates a constraint capture process. The system requests (or infers from the denial context) the reason for denial. Denial reasons are stored as constraints associated with the action type. For example, if a human denies the removal of a device with the reason ‘device is reserved for manual testing this week,’ the system stores a time-bound constraint that prevents similar removal requests for the specified period.

A denial also resets the trust score for the specific action type to a configurable reset value (e.g., 0.30), regardless of the prior trust score. This ensures that a single denial causes the system to re-enter a supervised mode for that action type, and trust must be rebuilt through subsequent approvals. The reset is scoped to the specific composite key (action type+impact+responsibility+authority) and does not affect trust scores for other action types.

### E. Delegation Templates

To accelerate the trust learning process and to encode organizational policies, the system supports delegation templates—predefined rules that pre-seed the delegation policy table. Templates may specify rules such as: ‘Auto-approve all coverage tier snapshot activation changes that do not increase the total device count beyond N’; ‘Auto-approve all known-issue markings for defects in open status’; ‘Auto-approve all orchestration retry mechanism’ or ‘Require mandatory approval for all actions that interact with the external defect tracking system.’ Templates override the trust score-based tier classification for matching actions, providing a mechanism for explicit human governance that coexists with the progressive trust learning.

### F. Chain of Accountability

All actions taken by the system, whether autonomous or approved, are logged to an immutable audit trail. Each audit entry includes: the action taken; the responsibility scope from which the action originated; the trigger event that initiated the action; the autonomy tier at which the action was classified; the trust score at the time of action; for approved actions, the approving authority and response time; the outcome of the action; and any subsequent corrective actions. This audit trail supports compliance requirements and provides the evidentiary basis for trust score computation.

### VI. Enhanced Natural Language Step Set (NLSS) Framework

The NLSS framework described in the referenced provisional application is enhanced in the present invention through integration with the Application Context Model and the Event-Driven Scenario Lifecycle and intelligent Test orchestrator.

### A. Context-Aware and Intent-Informed NLSS Generation

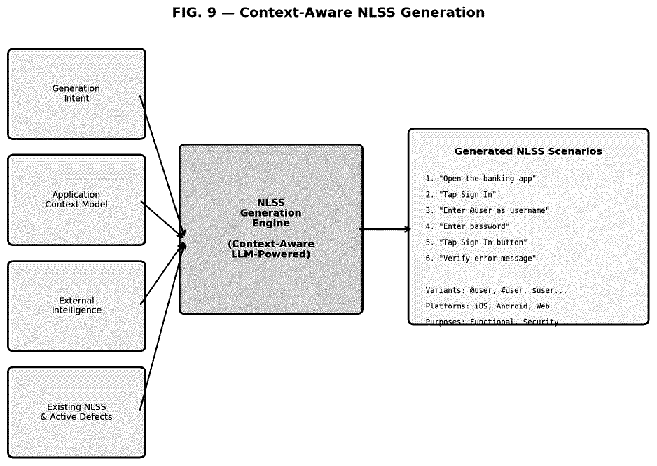

Referring now to FIG. 9, NLSS generation in the present invention is driven by the Application Context Model rather than relying solely on external source material. The NLSS generation engine receives: a generation intent (e.g., ‘generate scenarios for the login flow,’ ‘reproduce defect #12345,’ ‘cover the payment transaction path’); the Application Context Model providing full screen graph, element catalog, and transition map and intent layer; external intelligence from the context model (market data, customer metrics, performance baselines); existing NLSS scenarios for deduplication and coverage optimization; and active defect records for known-issue awareness.

The generation engine produces NLSS scenarios that are grounded in the application's actual structure. Each generated step references specific screens and elements from the context model, ensuring that generated scenarios are executable and relevant. The intent layer enriches generation by guiding the system to produce assertions that verify business-relevant outcomes (e.g., for a payment flow, asserting that the transaction amount is correct and the confirmation is displayed, rather than merely asserting that a button click navigated to the next screen). The engine also optimizes the scenario set to avoid redundant coverage while maximizing the diversity of tested paths, data patterns, and platform-specific behaviors.

### B. NLSS Generation from multiple Source Types

As described in the referenced provisional application, NLSS scenarios may be generated from a plurality of source types including: user stories and epics from requirements management systems; UX design tools (e.g., Figma) through semantic interpretation of screen designs; existing test scenarios and screen recordings through semantic analysis of UI flows; production usage monitoring through user behavior analytics tools; production logs and APM systems; and video recordings through semantic video analysis. Each source type feeds into the Application Context Model and/or directly into the NLSS generation engine. The system supports generation from one or more of these source types simultaneously.

### C. Natural Language Data and Environment Generation

As described in the provisional application, the system generates test data and environment configurations from natural language descriptions. In the present invention, these descriptions are enriched by the Application Context Model and resolved through the coverage tier management system. For test data, the system interprets natural language descriptions (e.g., ‘generate 50 German names,’ ‘generate current exchange rates for top 50 currencies’) and produces ephemeral test data sets. For environment configurations, natural language descriptions (e.g., ‘test on the device mix that covers 80% of the Canadian market for a banking application’) are resolved through the coverage tier policy resolution engine, which maps the description to a concrete, auditable device set using current analytics data.

### D. Multi-Platform and Multi-Purpose Execution

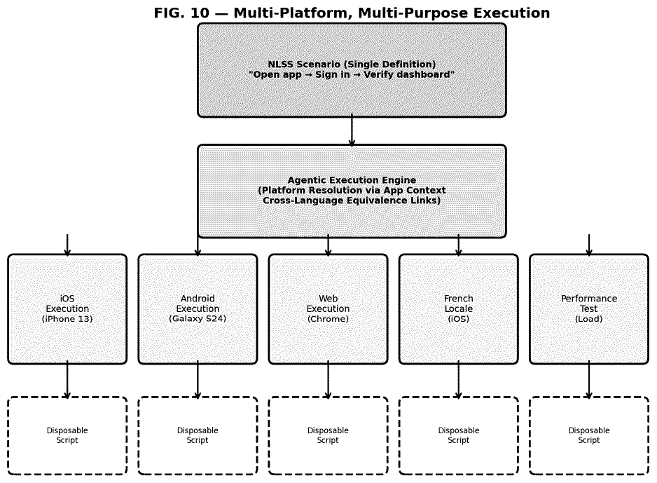

Referring now to FIG. 10, the system's multi-platform and multi-purpose execution capabilities are enhanced by the cross-language and cross-platform unification in the Application Context Model. When an NLSS scenario references a screen or element, the system automatically resolves the reference to the platform-appropriate and locale-appropriate equivalent using the equivalence links in the screen graph. This enables a single NLSS scenario to be executed across iOS, Android, web, and desktop platforms without modification, and across multiple language locales without translation effort.

A single NLSS scenario may serve multiple testing purposes including functional testing, user experience (UX) testing, performance or load testing, security validation, accessibility auditing, and synthetic monitoring. The system translates the scenario into purpose-specific execution through the Agentic Execution Engine and, where applicable, the Disposable Script Generator.

### E. Disposable Script Generation and Agentic Fallback

The system supports a disposable script generation mechanism wherein the Agentic Execution Engine's resolution of NLSS steps into platform-specific interactions may be captured and compiled into traditional test scripts (e.g., Selenium, Appium). These generated scripts are treated as ephemeral artifacts—they are regenerated from the NLSS source on demand and are not maintained independently.

The system employs a feedback loop mechanism: when a disposable script encounters an error or unknown locator during execution, the system reverts to the Agentic Execution Engine, which re-interprets the original natural language step, retrieves or updates context, and resolves the appropriate action. This feedback loop enables the system to tolerate changes in the application's UI without requiring manual script maintenance.

For performance testing, the system supports conversion of recorded network traffic or HAR logs into performance test scripts through an AI correlation engine that identifies semantic patterns in API calls, reduces false correlations using contextual matching of parameter values, and generates performance test scripts as part of the disposable script output.

### VII. Example Workflow 1: Defect Report to Resolution

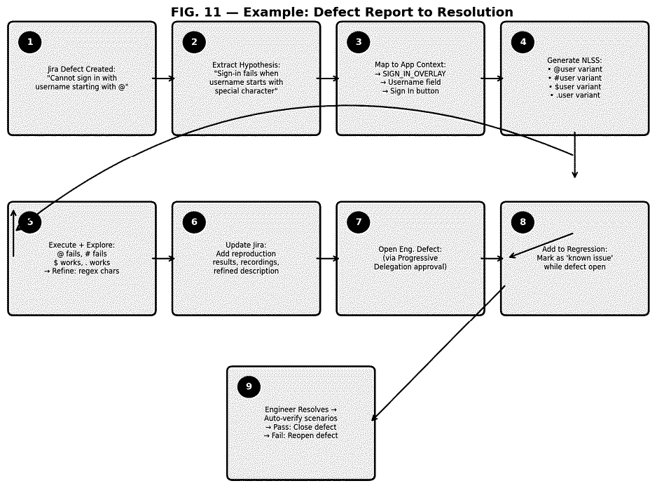

Referring now to FIG. 11, an example workflow illustrates the integrated operation of the system's subsystems.

Step 1: A customer support agent creates a defect report in the organization's Jira instance with the description: ‘Multiple customers report being unable to sign in when their username starts with a special character. Error message: Invalid credentials.’

Step 2: The Event-Driven Scenario Lifecycle subsystem receives the Jira webhook event and extracts the problem hypothesis: ‘Sign-in fails when username begins with a special character.’

Step 3: The system maps the hypothesis to the Application Context Model, identifying the SIGN_IN_OVERLAY screen (and its cross-language equivalent LOGIN_SCREEN), the ‘Client Card or Username’ text field, and the ‘Sign In’ button. The intent layer identifies this as security-critical authentication flow.

Step 4: The NLSS generation engine produces multiple reproduction scenarios with varying data patterns: username starting with ‘@’, ‘#’, ‘$’, ‘.’, and other special characters, tested against the sign-in flow.

Step 5: The Intelligent Test Orchestrator distributes the scenarios across devices in the current ‘sanity’ coverage tier snapshot. The Agentic Execution Engine executes the scenarios. Results show that usernames starting with ‘@’ and ‘#’ fail while other special characters work correctly. The system refines the hypothesis through agentic exploration, discovering that the issue is specific to characters that have special meaning in the application's input validation regex.

Step 6: The Insights Engine processes the results and, through the configured connectors, updates the Jira ticket with detailed reproduction results, including which specific characters cause failures, the exact error behavior observed, references to executed scenario recordings, and a refined problem description.

Step 7: Subject to the progressive delegation mechanism (initially requiring human approval, potentially auto-executing after trust is established), the system opens an engineering defect with the refined description and links it to the original support ticket.

Step 8: The reproduction scenarios are added to the nightly regression suite. While the defect remains open, affected test results are marked as ‘known issue.’

Step 9: When an engineer resolves the defect and transitions it to ‘Resolved’ status, the system automatically re-executes the reproduction scenarios. If all pass, the defect is verified and the ‘known issue’ markings are removed. If any fail, the defect is automatically reopened with updated diagnostic information.

### VIII. Example Workflow 2: Coverage Tier Drift Detection to Resolution

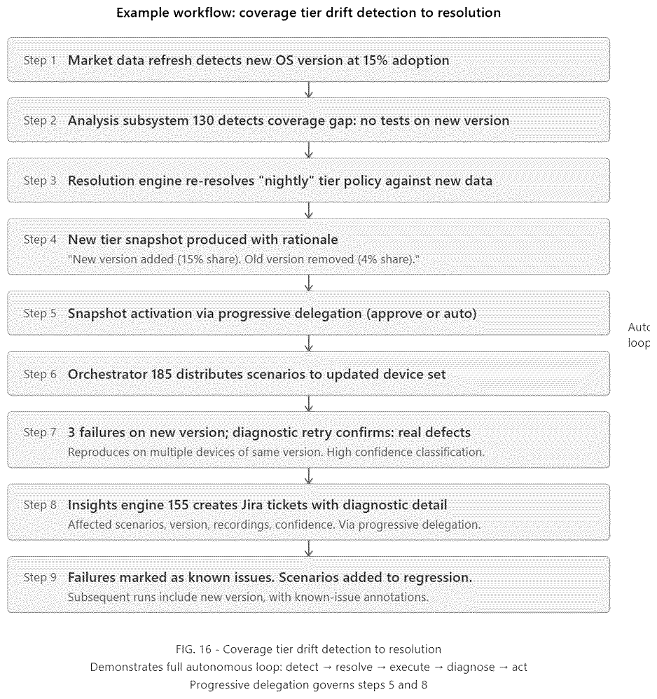

Referring now to FIG. 16, a second example workflow illustrates the coverage tier management and intelligent orchestration capabilities.

Step 1: The system's scheduled market data refresh detects that a new Android operating system version has reached 15% adoption among the application's user base, as reported by the connected Firebase analytics source.

Step 2: The Self-Optimizing Test Analysis subsystem detects a coverage gap: no test scenarios have executed on the new Android version, and the ‘nightly’ coverage tier policy includes a rule specifying ‘top 3 Android versions by user base share.’

Step 3: The coverage tier resolution engine is triggered by the market share shift event. It re-resolves the ‘nightly’ tier policy against current analytics data and determines that the new Android version now qualifies as a top-3 version, displacing the oldest version in the previous snapshot.

Step 4: The resolution engine produces an updated tier snapshot with a resolution rationale: ‘Android [new version] added (15% user base, up from 3% at last resolution). Android [old version] removed (user base declined to 4%).’

Step 5: Subject to the progressive delegation mechanism, the updated tier snapshot is activated. Initially, this may require explicit human approval. After several cycles of consistent approval, trust accumulates and snapshot activations may proceed with expedited approval or auto-execution with notification.

Step 6: The next nightly execution run uses the updated tier snapshot. The Intelligent Test Orchestrator distributes scenarios across the updated device set, including devices running the new Android version.

Step 7: Execution reveals 3 scenario failures specific to the new Android version. The orchestrator's diagnostic failure classification performs retry sequences: the failures reproduce on different devices running the same Android version but do not reproduce on devices running other versions. The orchestrator classifies these as confirmed platform-specific defects with high confidence.

Step 8: The Insights Engine processes the classified failures and, subject to progressive delegation, creates Jira tickets for each confirmed defect with platform-specific diagnostic detail, including: the affected scenarios, the specific Android version, the failure behavior, references to execution recordings, and the confidence classification.

Step 9: The three failures are marked as known issues for the new Android version. The reproduction scenarios are added to the regression suite. Subsequent nightly runs continue to include the new version in the tier, with known-issue annotations preventing false-positive noise.

This workflow demonstrates the full autonomous loop: detect market change, resolve coverage tier, execute with intelligent distribution, diagnose failures with confidence, and act on findings—with progressive human delegation governing the system's authority at each step.

What is claimed is:

1. A computer-implemented method for autonomously constructing and maintaining an application context model for software testing, the method comprising:
(a) ingesting data from one or more sources, wherein the sources comprise at least one of: video recordings of application interactions, design tool exports, application screenshots, application documentation, publicly or privately available media, requirements documentation, and domain knowledge sources;
(b) extracting screen definitions from the ingested sources, each screen definition comprising a screen identifier, a semantic description, a screen type classification, and a set of user interface element definitions, each element definition comprising at least an element type, a semantic name, and a natural language description;
(c) constructing a directed graph of screen transitions from temporal flow analysis of video sources or structural analysis of design sources, wherein each transition edge associates a source screen, a target screen, and a triggering element or condition;
(d) performing cross-language and cross-platform semantic unification to identify logically equivalent screens observed in different languages or on different platforms, the unification comprising structural comparison of element composition, semantic similarity of element names using multilingual language models, and transition graph topology comparison;
(e) constructing an intent layer by inferring business purpose and criticality of screens and flows from one or more of: requirements documentation, domain knowledge, user behavior analytics, and element naming semantics;
(f) integrating external intelligence comprising at least device ecosystem market data and customer base information into the application context model; and
(g) incrementally updating the application context model as new observations from test executions, design updates, or external data refreshes become available, including comparing observed application state during agentic test execution against the model and flagging discrepancies as detected application changes.

2. The method of claim 1, wherein the sources comprise at least two of: video recordings, design tool exports, application screenshots, application documentation, publicly available media, requirements documentation, and domain knowledge sources.

3. The method of claim 2, wherein the at least two sources comprises video recordings, and wherein extracting screen definitions from video recordings comprises: identifying distinct screens through visual change detection in the video; determining screen dwell times and transition points; identifying user interface elements within each screen using visual analysis; assigning semantic names and descriptions to identified elements; and recording appearance metadata including temporal position, duration, source execution identifier, platform, and device model.

4. The method of claim 1, wherein the cross-language and cross-platform semantic unification further comprises visual similarity comparison of screen layouts when screenshots are available, and wherein identified equivalence links enable natural language test scenarios written against one locale or platform to be automatically adapted for execution on another locale or platform.

5. The method of claim 1, further comprising: when a source provides screen definitions without flow information, flagging the screens as having incomplete transition data; and invoking a human-in-the-loop process, managed through a progressive delegation mechanism, to supply missing transition information.

6. The method of claim 1, wherein the intent layer assigns to screens and flows one or more of: a business purpose classification, a criticality rating, a regulatory sensitivity assessment, and a platform sensitivity assessment; and wherein the intent layer influences one or more of: test scenario generation priority, assertion selection, coverage tier allocation, and risk assessment for failure classification.

7. The method of claim 1, wherein the external intelligence comprises market share data by device manufacturer, operating system version distribution, screen resolution prevalence, and regional device preferences; and wherein the method further comprises using the external intelligence to resolve natural language environment descriptions into specific device and configuration lists.

8. The method of claim 1, further comprising:
parsing the ingested data to generate a Natural Language Step Set (NLSS) scenario comprising natural language-defined steps that encapsulate testing actions, wherein the NLSS preserves semantic intent without constraining step definitions to a programming language format; and
applying the NLSS scenario to multiple testing purposes selected from at least two of: functional testing, user experience testing, performance testing, security validation, accessibility auditing, and synthetic monitoring, without requiring manual scenario rework.

9. A computer-implemented method for event-driven test scenario generation and closed-loop defect lifecycle management, the method comprising:
(a) monitoring, by a computing system, a plurality of event sources comprising at least one external event source selected from: defect tracking systems, customer support channels, CI/CD pipeline systems, production monitoring systems, and security advisory feeds; and incoming support tickets; and at least one internal event source derived from the system's own execution results or analysis;
(b) upon receiving an event from a monitored source, parsing event content to extract a problem hypothesis expressed in natural language;
(c) mapping the problem hypothesis to an application context model comprising a directed graph of application screens, user interface elements, screen transitions and an intent layer indicating business purpose and criticality, to identify relevant portions of the application;
(d) generating one or more natural language test scenarios targeting the relevant portions of the application, the scenarios designed to reproduce or validate the suspected problem described in the problem hypothesis;
(e) executing the generated scenarios using an agentic execution engine capable of dynamically generating additional scenario steps based on intermediate execution results to refine problem understanding;
(f) classifying execution results and dispatching one or more actions including but not limited to: updating the originating event source with reproduction results, opening a defect record in an engineering tracking system, adding reproduction scenarios to a regression test suite, adjusting testing configuration; and modifying test environment configurations;
(g) maintaining a defect record that includes execution behavior directives defining how the defect affects ongoing test execution; the directives communicated to a test orchestration engine to influence runtime execution decisions; and
(h) upon detecting a defect status transition to resolved, automatically executing associated reproduction scenarios and, based on the results, either verifying and closing the defect record or reopening the defect with updated diagnostic information.

10. The method of claim 9, wherein the execution behavior directives comprise at least one of: marking test results exercising affected functionality as ‘known issue’ rather than ‘failure’; skipping execution of scenarios that are blocked by the defect; and continuing execution while collecting diagnostic data for defect resolution; and deprioritizing affected scenarios in orchestration distribution decisions.

11. The method of claim 9, wherein generating natural language test scenarios comprises producing multiple scenario variants that explore different aspects of the problem hypothesis, including varying data patterns, platform configurations, and user flow paths.

12. The method of claim 9, wherein the agentic execution engine refines the problem hypothesis based on intermediate results, and wherein refinement comprises: identifying conditions under which the suspected problem manifests; identifying conditions under which the suspected problem does not manifest; and generating a refined problem description that is more specific than the original hypothesis.

13. The method of claim 9, further comprising: identifying untested paths in the application context model's directed graph by comparing the graph against recorded test execution coverage; autonomously generating exploratory execution sequences that traverse the untested paths using agentic execution; updating the application context model with newly discovered screens, elements, and transitions encountered during exploratory execution; and generating candidate test scenarios from successful exploratory sequences.

14. The method of claim 9, further comprising monitoring the system's own execution results as an internal event source, including: detecting statistically significant failure clusters across one or more dimensions including but not limited to platform, operating system version, device model, feature area, and time period; generating targeted investigation scenarios in response to detected clusters; and triggering corrective actions based on investigation results.

15. The method of claim 9, further comprising: monitoring production telemetry and adjusting performance testing parameters in response to changes in observed production usage patterns; and monitoring security advisory feeds and generating security validation scenarios when a published vulnerability is mapped to a component of the application's technology stack.

16. The method of claim 9, further comprising:
parsing the plurality of event source inputs to generate a Natural Language Step Set (NLSS) scenario comprising natural language-defined steps that encapsulate testing actions, wherein the NLSS preserves semantic intent without constraining step definitions to a programming language format;
generating from the NLSS scenario one or more disposable, platform-specific test scripts for execution on a test grid, the scripts treated as ephemeral artifacts regenerated from the NLSS on demand;
executing the disposable scripts on the test grid and, upon detecting a fault during execution, reverting to an agentic AI execution module that re-interprets the original natural language step and recomputes the appropriate action; and
applying the NLSS scenario to multiple testing purposes selected from at least two of: functional testing, user experience testing, performance testing, security validation, accessibility auditing, and synthetic monitoring, without requiring manual scenario rework.

17. A computer-implemented method for autonomous software testing management with progressive human-in-the-loop delegation, the method comprising:
(a) defining, by a computing system, a plurality of responsibility scopes, each responsibility scope comprising a description of the responsibility, one or more monitoring loops defining data sources and monitoring frequencies, and a set of potential actions;
(b) classifying each potential action into an autonomy tier selected from: auto-execute, expedited approval, and mandatory approval, based on at least the action's impact classification, reversibility assessment, and a computed trust score;
(c) maintaining a delegation policy table with entries indexed by a composite key comprising at least action type and impact classification, each entry storing at least: cumulative approval count, cumulative denial count, time-weighted approval ratio, and a computed trust score;
(d) computing the trust score from at least: historical approval patterns and the action's reversibility classification, wherein reversible actions accumulate trust at a faster rate than irreversible actions;
(e) for auto-execute tier actions, executing the action autonomously, logging the action to an audit trail, and sending a notification to the designated authority;
(f) for expedited approval tier actions, sending an approval request through a configured communication channel with a configurable auto-approve timeout, and proceeding with the action if no denial is received within the timeout period;
(g) for mandatory approval tier actions, sending a detailed approval request and waiting for explicit human approval before proceeding;
(h) upon receiving a denial for any action, resetting the trust score for the action's composite key to a configurable reset value and initiating a constraint capture process to record the denial reason as a constraint on future decisions; and
(i) logging all actions, approvals, denials, and outcomes to an immutable audit trail.

18. The method of claim 17, further comprising: supporting delegation templates comprising predefined rules that pre-seed the delegation policy table and override trust score-based tier classification for matching actions, the templates encoding organizational policies regarding autonomous authority boundaries.

19. The method of claim 17, wherein trust scores are subject to decay over time such that if an action type has not been exercised for a configurable period, its trust score gradually decreases, preventing stale autonomy for actions whose context may have changed.

20. The method of claim 17, wherein the denial-driven constraint learning comprises: storing denial reasons as constraints associated with the action type; applying stored constraints as filters when evaluating future actions of the same type; and supporting time-bound constraints that expire automatically after a specified period.

21. The method of claim 17, wherein the expedited approval mechanism further comprises: adaptively adjusting the auto-approve timeout duration based on the historical average response time of the approving authority and the urgency classification of the action.

22. The method of claim 17, further comprising: a reversibility assessment for each action type, wherein the trust score computation further considers the consistency of the approving authority's decisions and a minimum decision count requirement before trust may exceed the auto-execute threshold.
